(19) United States
(12) Patent Application Publication
(10) Pub. No.: US 2025/0238283 A1
(43) Pub. Date: Jul. 24, 2025

(54) METHOD AND SYSTEM OF OPTIMIZING RESOURCE UTILIZATION IN CLOUD-BASED DATA PROCESSING PLATFORM

(71) Applicant: HCL Technologies Limited, Delhi (IN)

(72) Inventors: Deepak Kumar Dixit, Woodland, CA (US); Pandu Rangaiah Pabbisetty, Fremont, CA (US)

(21) Appl. No.: 18/910,369

(22) Filed: Oct. 9, 2024

(30) Foreign Application Priority Data
Jan. 24, 2024 (IN) 202411004857

(51) Int. Cl. G06F 9/50; G06F 9/455; G06F 9/54

(52) U.S. Cl. CPC G06F 9/5083; G06F 9/45558; G06F 9/547; G06F 2009/45595

(57) ABSTRACT

A method and system for optimizing resource utilization in cloud-based data processing platforms is disclosed. A set of usage metrics of the data cluster is received for each cluster of a plurality of data clusters using a web crawler. A justification based on a predefined threshold is determined corresponding to each of the set of usage metrics of the data cluster through one or more application programming interfaces (APIs). One or more recommendations are generated based on the justification for optimal usage of the data cluster through the one or more APIs. The one or more recommendations are executed through at least one of an associated configuration file or the one or more APIs.

### TECHNICAL FIELD

This disclosure relates generally to cloud-based data processing, and more particularly to method and system for optimizing resource utilization in cloud-based data processing platforms.

### BACKGROUND

In the current industry trend, organizations are grappling with the challenge of overspending on cloud services, often exceeding their budgets by a substantial margin. This phenomenon is driven by the increasing adoption of cloud services and infrastructure as businesses seek to leverage the scalability, flexibility, and cost-efficiency offered by the cloud. However, this has also led to a pressing need to optimize cloud spending, as recent analyses indicate that approximately 80% of organizational cloud projects are overshooting their allocated budgets. Furthermore, the move towards multi-cloud environments, where organizations utilize multiple cloud providers for different aspects of their operations, intensifies the importance of monitoring and managing cloud costs to ensure sustainable growth. This challenge becomes even more significant when organizations rely on data services for processing, querying, and streaming vast amounts of data, often in the order of petabytes.

These complexities encompass various limitations, challenges to be faced may highlight the intricacies involved in optimizing cloud costs, particularly when numerous projects within an organization rely on complex managed services. As organizations continue to embrace the cloud for their digital transformation, addressing these cost optimization challenges will remain a critical concern for efficient and sustainable resource utilization in cloud-based data processing platforms.

Therefore, there is a need for an efficient methodology of optimizing resource utilization in cloud-based data processing platforms.

### SUMMARY OF THE INVENTION

In an embodiment, a method of optimizing resource utilization in cloud-based data processing platforms is provided. The method may include receiving a set of usage metrics for each data cluster of a plurality of data clusters in a cloud-based data processing platform using a web crawler. The method may further include determining a justification based on a predefined threshold corresponding to each of the set of usage metrics of the data cluster through one or more application programming interfaces (APIs). The method may further include generating one or more recommendations based on the justification for optimal usage of the data cluster through the one or more APIs. The method may further include executing the one or more recommendations through at least one of an associated configuration file or the one or more APIs.

In another embodiment, a system of optimizing resource utilization in cloud-based data processing platform is disclosed. The system may include a processor, a memory communicably coupled to the processor, wherein the memory may store processor-executable instructions, which when executed by the processor may cause the processor to receive a set of usage metrics for each data cluster of a plurality of data clusters in a cloud-based data processing platform using a web crawler. The processor-executable instructions, when executed by the processor, may further cause the processor to determine a justification based on a predefined threshold corresponding to each of the set of usage metrics of the data cluster through one or more APIs. The processor-executable instructions, when executed by the processor, may further cause the processor to generate one or more recommendations based on the justification for optimal usage of the data cluster through the one or more APIs. The processor-executable instructions, when executed by the processor, may further cause the processor to execute the one or more recommendations through at least one of an associated configuration file or the one or more APIs.

In another embodiment, a non-transitory computer-readable medium storing computer-executable instructions for optimizing resource utilization in cloud-based data processing platform is disclosed. In one example, the stored instructions, when executed by a processor, cause the processor to perform operations including, for each data cluster of a plurality of data clusters in a cloud-based data processing platform, receiving a set of usage metrics of the data cluster using a web crawler. The operations further include determining a justification based on a predefined threshold corresponding to each of the set of usage metrics of the data cluster through one or more APIs. The operations further include generating one or more recommendations based on the justification for optimal usage of the data cluster through the one or more APIs. The operations further include executing the one or more recommendations through at least one of an associated configuration file or the one or more APIs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary system for optimizing resource utilization in cloud-based data processing platforms, in accordance with an embodiment of the present disclosure.

FIG. 2 illustrates a functional block diagram of a processing device, in accordance with an embodiment of the present disclosure.

FIG. 3 is an exemplary table depicting information regarding a plurality of data clusters, in accordance with an embodiment of the present disclosure.

FIG. 4 is an exemplary table depicting information regarding data clusters for migration to ephemeral type, in accordance with an embodiment of the present disclosure.

FIG. 5 illustrates a flowchart of an exemplary method of optimizing resource utilization in cloud-based data processing platforms, in accordance with an embodiment of the present disclosure.

FIG. 6 illustrates a flowchart of a detailed exemplary control logic for optimizing resource utilization in cloud-based data processing platforms, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

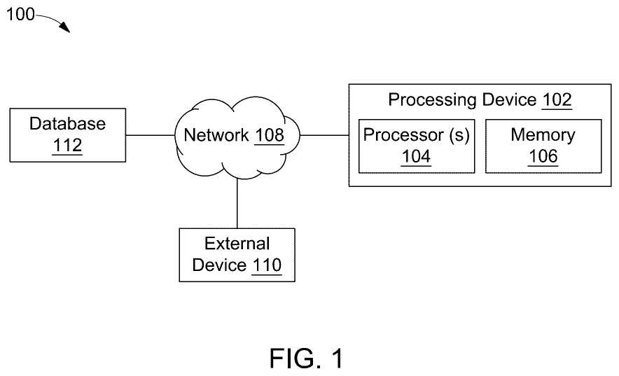

FIG. 1 illustrates a block diagram indicating an exemplary system 100 for optimizing resource utilization in cloud-based data processing platforms, in accordance with an embodiment of the current disclosure. The system 100 may include a processing device 102. The processing device 102 may include a processor 104, and a memory 106.

In an embodiment, examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors.

In an embodiment, the memory 106 may store instructions that when executed by the processor 104 may cause the processor 104 to optimize resource utilization in cloud-based data processing platform, as disclosed in more detail below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

The processing device 102 may be communicably coupled, through a wired or a wireless communication network 108, to an external device 110, and a database 112. In an embodiment, the network 108 can be implemented as one of the different types of networks, such as intranet, local area network (LAN), wide area network (WAN), Bluetooth, IEEE 802.11, the internet, Wi-Fi, LTE network, CDMA network, etc. Further, the wired or the wireless network can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with one another. Further the network 108 can include a variety of network devices, including routers, bridges, servers, computing devices, storage devices, and the like.

In an embodiment, the external device 110 may be accessed by a user. In such an embodiment, the processing device 102 may receive a request for optimizing resource utilization from the external device 110 through the network 108. The processing device 102 and the external device 110 may be smart phones, laptop computers, desktop computers, notebooks, servers, or any other computing devices. The external device 110 may also include a processor (not shown in figure) and a memory (not shown in figure). In some embodiments, the system 100 may not include an external device 110. In such embodiments, the processing device 102 may be accessible by a user.

In an embodiment, the database 112 may be enabled in a cloud or a physical database and may store a plurality of data clusters. It should be noted that a data cluster may include a group of data points that may be more similar to each other than they may be to data points in other of the plurality of data clusters. In some embodiments, the database 112 may be stored within the memory 106 of the processing device 102.

In an embodiment, the processing device 102 may perform various processing for optimizing resource utilization in cloud-based data processing platforms. A cloud-based data processing platform may include a plurality of data clusters. Examples of cloud-based data processing platforms may include, but are not limited to, Google® Dataproc, Amazon® EMR, Azure® HDInsight, IBM® analytics engine, Qubole®, DataBricks®, etc. The cloud-based data processing platform may analyze, and process data stored in a data lake. Examples of the web crawler may include, but are not limited to, Googlebot®, Bingbot®, Yahoo® Slurp, Scrapy, etc. For each data cluster of a plurality of data clusters in a cloud-based data processing platform, the processing device 102 may receive a set of usage metrics of the data cluster using a web crawler.

It may be noted that the set of usage metrics may include utilization information of each of a control processing unit, a memory, and a disk. Each of the plurality of data clusters may include one or more virtual machines. Each of the one or more virtual machines may be configured to perform a specific role within the data cluster. The processing device 102 may retrieve the set of usage metrics of each of the plurality of data clusters based on a predefined time interval.

Further, the processing device 102 may determine a justification based on a predefined threshold corresponding to each of the set of usage metrics of the data cluster through one or more Application Programming Interfaces (APIs) (e.g., Lambda API). The determination of the justification based on the predefined threshold may include comparing each of the set of usage metrics with the corresponding predefined threshold.

Further, the processing device 102 may generate one or more recommendations based on the justification for optimal usage of the data cluster through the one or more APIs. In some embodiments, the processing device 102 may further present the one or more recommendations to a user device via a Graphical User Interface (GUI). It should be noted that the user device may be the external device 110 (in embodiments where the external device 110 is accessible to the user) or the processing device 102 (in embodiments where the processing device 102 is accessible to the user).

Further, the processing device 102 may execute the one or more recommendations through at least one of an associated configuration file or the one or more APIs.

Further, the processing device 102 may identify a data cluster from the plurality of data clusters as an ephemeral data cluster based on the set of usage metrics. The processing device 102 may further reconfigure the identified data cluster to an ephemeral data cluster.

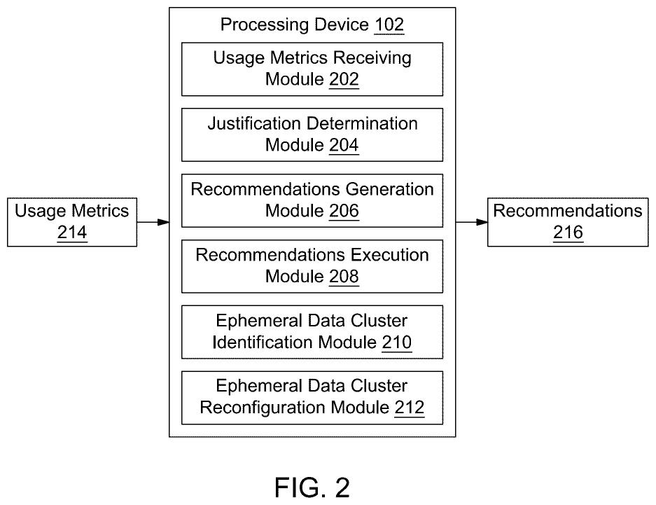

FIG. 2 illustrates a functional block diagram of the processing device 102, in accordance with an embodiment of the present disclosure. FIG. 2 is explained in conjunction with FIG. 1. In an embodiment, the processing device 102 may include a usage metrics receiving module 202, a justification determination module 204, a recommendations generation module 206, a recommendations execution module 208, an ephemeral data cluster identification module 210, and an ephemeral data cluster reconfiguration module 212.

A cloud-based data processing platform may include a plurality of data clusters. For each data cluster of the plurality of data clusters, the usage metrics receiving module 202 may receive a set of usage metrics 214 using a web crawler. It should be noted that a data lake is a centralized repository configured to store, process, and secure large amounts of structured, semi-structured, and unstructured data. The cloud-based data processing platform may analyze, and process data stored in the data lake. The usage metrics receiving module 202 may retrieve the set of usage metrics 214 of each of the plurality of data clusters based on a predefined time interval. The set of usage metrics 214 may include, for example, utilization information of each of a control processing unit, a memory, and a disk. The usage metrics receiving module 202 may retrieve the set of usage metrics through a centralized Continuous Integration and Continuous Delivery (CICD) framework (such as Jenkins).

In some embodiments, the usage metrics receiving module 202 may also receive budget data (e.g., monthly budget) in order to optimize resource utilization in light of financial constraints. The budget data may be retrieved through techniques such as, Governance Check (GC). The GC may include identifying the Business Unit (BU) and project from CICD pipeline/plugin input, getting the monthly budget for the identified application/project by using CloudHealth/Lambda API, estimating usage for the month based on last 1-2 days of usage using Lambda API, arriving at remaining budget for the application, calculate cost of resources being launched using Google Cost Estimation API, and allowing job if available budget (which is equal to (total monthly budget—estimated usage for the month from existing jobs—estimate of the cost of resources from the current template)) is greater than 0. It should be noted that budget data comes from FinOps team into Cloud Health and gets uploaded into RDS/MySQL using OneCloud scheduled jobs.

Further, the justification determination module 204 may receive the set of usage metrics 214 from the usage metrics receiving module 202. The justification determination module 204 may determine a justification based on a predefined threshold corresponding to each of the set of usage metrics 214 of the data cluster through one or more Application Programming Interfaces (APIs). The justification may imply an end objective to be achieved to optimize resource utilization of the cloud-based data processing platform. For example, justification determination module 204 may determine that a data cluster is underutilized. Then, the justification for the data cluster may be “downsize underutilized cluster”. To determine the justification, the justification determination module 204 may compare each of the set of usage metrics 214 with the corresponding predefined threshold.

Further, the recommendations generation module 206 may receive the justification from the justification determination module 204. The recommendations generation module 206 may generate one or more recommendations 216 based on the justification for optimal usage of the data cluster through the one or more APIs. The one or more recommendations 216 may include one or more actions to be performed to optimize the resource utilization in alignment with the justification. In continuation of the above example, the one or more recommendations 216 may suggest use of lesser number of cores. The one or more recommendations 216 generated may be “use ‘n2d-standard-8’ instead of ‘n2d-standard-16’”. In some embodiments, the recommendations generation module 206 may present the one or more recommendations 216 to a user device via a GUI. In some embodiments, the user device may be the same as the processing device 102. In such embodiments, the GUI may be rendered on a display corresponding to the processing device 102.

The GUI may show budget data and the set of usage metrics by BU ID, may allow budget modification/increase for a given BU ID with audit log (may be streamlined along the same lines as that of AWS/OCI), and may show application-level usage.

Further, the recommendations generation module 208 may execute the one or more recommendations 216 through at least one of an associated configuration file or the one or more APIs. The associated configuration file may be downloadable by the user through the GUI. In an embodiment, the associated configuration file may be an executable file, which when executed by a user action, may cause the recommendations generation module 208 to execute the one or more recommendations 216. Alternately, the recommendations generation module 208 may execute the one or more recommendations 216 automatically through an API.

Further, the ephemeral data cluster identification module 210 may identify a data cluster from the plurality of data clusters as an ephemeral data cluster based on the set of usage metrics. The ephemeral data cluster reconfiguration module 212 may further reconfigure the identified data cluster to an ephemeral data cluster. The processing device 102 may optimize cost for various key Google Cloud Platform (GCP) services such as, but not limited to, BigQuery.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for optimizing resource utilization in cloud-based data processing platforms. For example, the exemplary system 100 and the associated processing device 102 may optimize resource utilization in cloud-based data processing platforms by the processes discussed herein. In particular, as will be appreciated by those of ordinary skill in the art, control logic and/or automated routines for performing the techniques and steps described herein may be implemented by the system 100 and the associated processing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

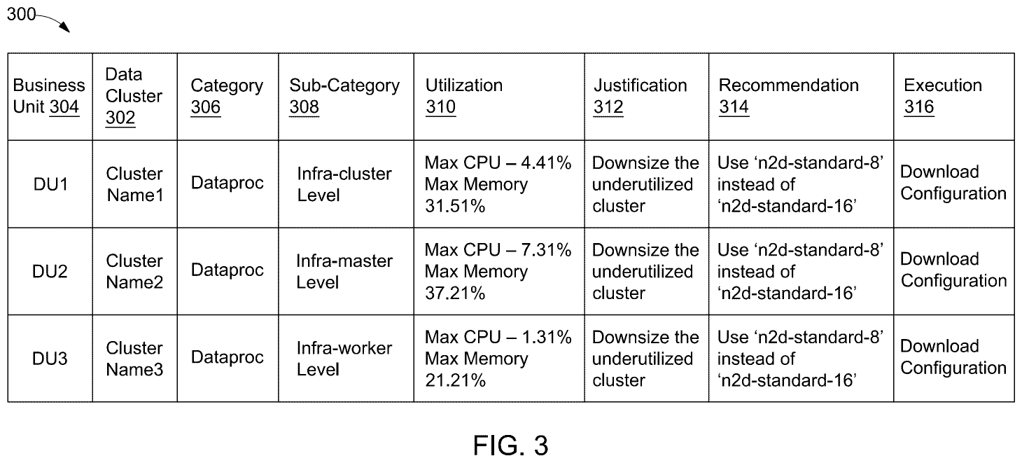

Referring now to FIG. 3, a table 300 depicting information regarding a plurality of data clusters is presented, in accordance with an embodiment of the present disclosure. FIG. 3 is explained in conjunction with FIGS. 1 and 2. Table 300 represents parameters corresponding to a data cluster 302. The parameters include business unit 304, category 306, sub-category 308, utilization 310, justification 312, recommendation 314, and execution 316. Parameters such as the business unit 304, the category 306, the sub-category 308, and the utilization 310 may be retrieved by the usage metrics receiving module 202. The utilization 310 may include a set of usage metrics (for example, maximum CPU utilization, maximum memory utilization, etc.). Other parameters such as the justification 312, the recommendation 314, and the execution 316 may be generated by the justification determination module 204, the recommendations generation module 206, and the recommendations execution module 208, respectively.

By way of an example, a predefined threshold for each of the set of usage metrics in the utilization 310 column may be 50. Further, maximum and average limits corresponding to each of CPU and memory utilization may be predefined (for example, maximum CPU utilization limit may be 40, average CPU utilization limit may be 20, maximum memory utilization limit may be 40, and average memory utilization limit may be 20.

Further, the business unit 304 associated with the data cluster 302 ‘ClusterName1’ may be ‘DU1’, the business unit 304 associated with the data cluster 302 ‘ClusterName2’ may be ‘DU2’, and the business unit 304 associated with the data cluster 302 ‘ClusterName3’ may be ‘DU3’. The category 306 corresponding to the data cluster 302 ‘ClusterName1’ may be ‘Dataproc’, the category 306 corresponding to the data cluster 302 ‘ClusterName2’ may be ‘Dataproc’, and the category 306 corresponding to the data cluster 302 ‘ClusterName3’ may be ‘Dataproc’. The sub-category 308 corresponding to the data cluster 302 ‘ClusterName1’ may be ‘Infra-clusterLevel’, the sub-category 308 corresponding to the data cluster 302 ‘ClusterName2’ may be ‘Infra-masterLevel’, and the sub-category 308 corresponding to the data cluster 302 ‘ClusterName3’ may be ‘Infra-workerLevel’.

The utilization 310 corresponding to the data cluster 302 ‘ClusterName1’ may be ‘Max CPU—4.41%, Max Memory 31.51%’. The utilization 310 corresponding to the data cluster 302 ‘ClusterName2’ may be ‘Max CPU—7.31%, Max Memory 37.21%’. The utilization 310 corresponding to the data cluster 302 ‘ClusterName3’ may be ‘Max CPU—1.31%, Max Memory 21.21%’.

As can be seen, each of the ‘ClusterName1’, ‘ClusterName2’, and ‘ClusterName3’ have Max CPU and Max Memory utilization below the corresponding limits. The justification determination module 204 may generate the justification 312 based on the comparison of the Max CPU and Max Memory utilization with the corresponding limits. The justification 312 for each of the ‘ClusterName1’, ‘ClusterName2’, and ‘ClusterName3’ may be ‘Downsize the underutilized cluster’. Further, the recommendation 314 generated by the recommendations generation module 206 for each of the ‘ClusterName1’, ‘ClusterName2’, and ‘ClusterName3’ may be ‘Use ‘n2d-standard-8’ instead of ‘n2d-standard-16’’. Further, for the execution of the recommendation 314, a downloadable configuration file may be generated by the recommendations execution module 208.

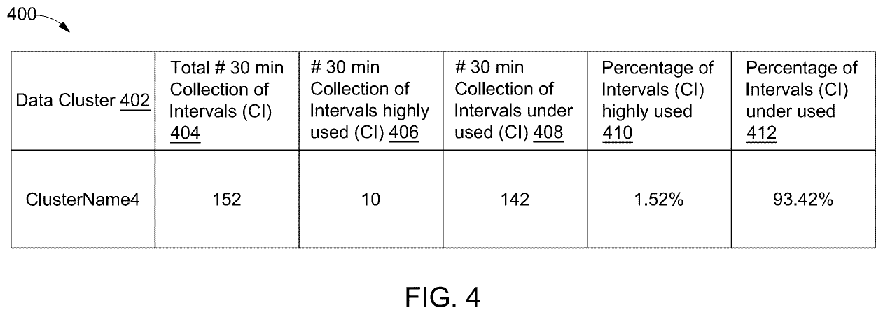

Referring now to FIG. 4, a table 400 depicting information regarding data clusters for migration to ephemeral type is presented, in accordance with an embodiment of the present disclosure. FIG. 4 is explained in conjunction with FIGS. 1, 2, and 3. The ephemeral data cluster identification module 210 may identify a data cluster from the plurality of data clusters as an ephemeral data cluster based on the set of usage metrics. The set of usage metrics corresponding to a data cluster 402 may be total number of 30-minute collection of intervals (CI) 404, number of 30-minute collection of intervals (CI) highly used 406, number of 30-minute collection of intervals under used (CI) 408, number of 30-minute percentage of intervals (CI) highly used 410, and number of 30-minute percentage of intervals (CI) under used 412. By way of an example, for a data cluster 402 ‘ClusterName4’, the total number of 30-minute collection of intervals (CI) 404 may be 152, the number of 30-minute collection of intervals (CI) highly used 406 may be 10, the number of 30-minute collection of intervals under used (CI) 408 may be 142, the percentage of number of 30-minute intervals (CI) highly used 410 may be 1.52%, and the percentage of number of 30-minute intervals (CI) under used 412 may be 93.42%.

Thus, the ephemeral data cluster identification module 210 may identify the ‘ClusterName4’ as a candidate for an ephemeral data cluster since it is underutilized for a majority of 30-minute intervals. Further, the ephemeral data cluster reconfiguration module 212 may reconfigure the identified data cluster to an ephemeral data cluster.

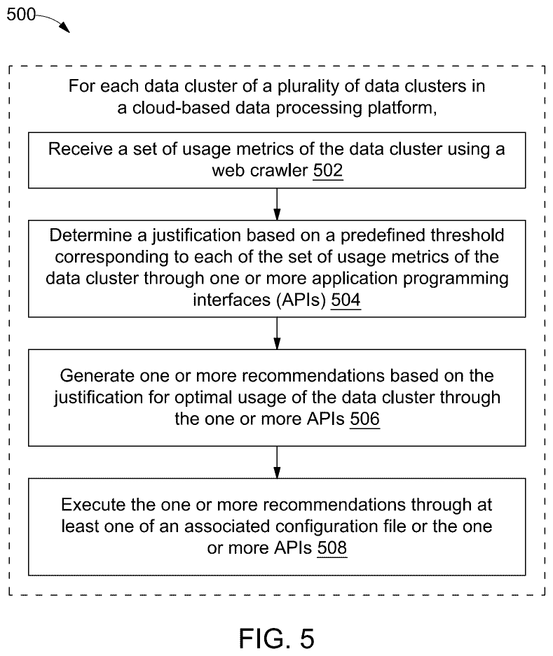

Referring now to FIG. 5, an exemplary method 500 of optimizing resource utilization in cloud-based data processing platforms is explained via a flow chart, in accordance with an embodiment of the present disclosure. FIG. 5 is explained in conjunction with FIGS. 1, 2, 3, and 4. Each step of the method 500 may be executed by various modules, same as the modules of the processing device 102.

At step 502 of the method 500, for each data cluster of a plurality of data clusters in a cloud-based data processing platform, the usage metrics receiving module 202 of the processing device 102 may receive a set of usage metrics (such as the set of usage metrics 214) of the data cluster using a web crawler. It may be noted that each of the plurality of data clusters may include one or more virtual machines. It may also be noted that each of the one or more virtual machines may be configured to perform a specific role within the data cluster. In some embodiments, the usage metrics receiving module 202 may retrieve the set of usage metrics of each of the plurality of data clusters based on a predefined time interval. By way of an example, the set of usage metrics comprises utilization information of each of a control processing unit, a memory, and a disk.

At step 504 of the method 500, the justification determination module 204 of the processing device 102 may determine a justification based on a predefined threshold corresponding to each of the set of usage metrics of the data cluster through one or more APIs. It may be noted that to determine the justification based on the predefined threshold, the justification determination module 204 may compare each of the set of usage metrics with the corresponding predefined threshold.

At step 506 of the method 500, the recommendations generation module 204 of the processing device 102 may generate one or more recommendations (such as the one or more recommendations 216) based on the justification for optimal usage of the data cluster through the one or more APIs.

At step 508 of the method 500, the recommendations execution module 208 of the processing device 102 may execute the one or more recommendations (such as the one or more recommendations 216) through at least one of an associated configuration file or the one or more APIs.

Additionally, the method 500 may include identifying, by the ephemeral data cluster identification module 210, a data cluster from the plurality of data clusters as an ephemeral data cluster based on the set of usage metrics. Further, the method 500 may include reconfiguring, by the ephemeral data cluster reconfiguration module 212, the identified data cluster to an ephemeral data cluster. In some embodiments, the method 500 may include presenting, by the recommendations generation module 206, the one or more recommendations to a user device via a GUI.

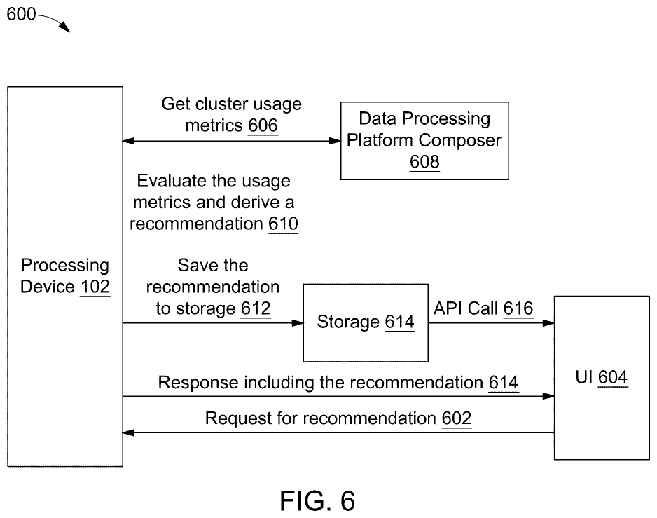

Referring now to FIG. 6, a detailed exemplary control logic 600 for optimizing resource utilization in cloud-based data processing platforms is explained via a flow chart, in accordance with an embodiment of the present disclosure. FIG. 6 is explained in conjunction with FIGS. 1, 2, 3, 4, and 5. Each step of the control logic 600 may be executed by various modules, same as the modules of the processing device 102.

At step 602 of the control logic 600, the processing device 102 may receive a request for recommendation from a UI 604 (for example, OneCloud UI). The request for recommendation may be automatically received periodically (for example, every 30 minutes) or may be received via a user command. The UI 604 may show budget and usage data by BU ID, may allow budget modification/increase for a given BU ID with audit log (may be streamlined along the same lines as that of AWS/OCI), and may show application-level usage. It should be noted that UX design may follow existing AWS budget/reports format.

At step 606 of the control logic 600, the processing device 102 may retrieve usage metrics of the data cluster from a cloud-based data processing platform (e.g., Dataproc, BigQuery (BQ), Google Cloud Storage (GCS), etc.) composer 608. The cluster usage metrics may include, but may not be limited to, utilization information of each of a control processing unit, a memory, and a disk.

At step 610 of the control logic 600, the processing device 102 may evaluate the cluster usage metrics and derive a recommendation (such as the one or more recommendations 216) corresponding to the cluster.

At step 612 of the control logic 600, the processing device 102 may save the generated recommendation to a storage 614.

At step 614 of the control logic 600, the processing device 102 may generate a response including the recommendation. The generated response may be rendered to the UI 604.

Additionally, at step 616 of the control logic 600, the generated recommendation may be retrieved by an API call and may then be rendered to the UI 604.

The UI 604 may display a link to the generated recommendation corresponding to each application. Upon clicking the link, the user may be able to access details about the recommendation. Further, in some implementations, a button (EASY kind) may be displayed for each application for automatically executing the recommendation. Upon clicking the button, optimized infrastructure may be redeployed or changes may be queried/configured.

Thus, the disclosed method and system try to overcome the technical problem of optimizing resource utilization in cloud-based data processing platforms. The method and system provide UI integration with OneCloud. Further, the method and system provide cost optimization for key Google Cloud Platform (GCP) managed services such as BQ and Dataproc. Further, the method and system provide for cost saving where Dataproc clusters are used for big data processing. This is beneficial for users who do not have in-depth knowledge of Dataproc and corresponding master and worker node compute engine configurations. The method and system provide recommendations on a regular basis (daily/weekly) or on-demand which may facilitate reduction and optimization of cost.

As will be appreciated by those skilled in the art, the techniques described in the various embodiments discussed above are not routine, or conventional, or well understood in the art. The techniques discussed above provide for optimizing resource utilization in cloud-based data processing platforms. For each data cluster of a plurality of data clusters in a cloud-based data processing platform, the techniques first receive a set of usage metrics of the data cluster using a web crawler. For each data cluster of a plurality of data clusters in a cloud-based data processing platform, the techniques then determine a justification based on a predefined threshold corresponding to each of the set of usage metrics of the data cluster through one or more Application Programming Interfaces (APIs). For each data cluster of a plurality of data clusters in a cloud-based data processing platform, the techniques then generate one or more recommendations based on the justification for optimal usage of the data cluster through the one or more APIs. For each data cluster of a plurality of data clusters in a cloud-based data processing platform, the techniques then execute the one or more recommendations through at least one of an associated configuration file or the one or more APIs.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for optimizing resource utilization in cloud-based data processing platforms. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method of optimizing resource utilization in cloud-based data processing platforms, the method comprising:
for each data cluster of a plurality of data clusters in a cloud-based data processing platform,
receiving, by a processing device, a set of usage metrics of the data cluster using a web crawler;
determining, by the processing device, a justification based on a predefined threshold corresponding to each of the set of usage metrics of the data cluster through one or more Application Programming Interfaces (APIs);
generating, by the processing device, one or more recommendations based on the justification for optimal usage of the data cluster through the one or more APIs; and
executing, by the processing device, the one or more recommendations through at least one of an associated configuration file or the one or more APIs.

2. The method of claim 1, further comprising retrieving, by the processing device, the set of usage metrics of each of the plurality of data clusters based on a predefined time interval.

3. The method of claim 1, wherein the set of usage metrics comprises utilization information of each of a control processing unit, a memory, and a disk.

4. The method of claim 1, wherein each of the plurality of data clusters comprises one or more virtual machines, wherein each of the one or more virtual machines is configured to perform a specific role within the data cluster.

5. The method of claim 1, further comprising:
identifying, by the processing device, a data cluster from the plurality of data clusters as an ephemeral data cluster based on the set of usage metrics; and
reconfiguring, by the processing device, the identified data cluster to an ephemeral data cluster.

6. The method of claim 1, further comprising presenting, by the processing device, the one or more recommendations to a user device via a Graphical User Interface (GUI).

7. The method of claim 1, wherein determining the justification based on the predefined threshold comprises comparing, by the processing device, each of the set of usage metrics with the corresponding predefined threshold.

8. A system for optimizing resource utilization in cloud-based data processing platform, comprising:
a processor; and
a memory communicatively coupled to the processor, wherein the memory stores processor-executable instructions, which when executed by the processor, cause the processor to:
for each data cluster of a plurality of data clusters in a cloud-based data processing platform,
receive a set of usage metrics of the data cluster using a web crawler;
determine a justification based on a predefined threshold corresponding to each of the set of usage metrics of the data cluster through one or more Application Programming Interfaces (APIs);
generate one or more recommendations based on the justification for optimal usage of the data cluster through the one or more APIs; and
execute the one or more recommendations through at least one of an associated configuration file or the one or more APIs.

9. The system of claim 8, wherein the processor-executable instructions, on execution, cause the processor to retrieve the set of usage metrics of each of the plurality of data clusters based on a predefined time interval.

10. The system of claim 8, wherein the set of usage metrics comprises utilization information of each of a control processing unit, a memory, and a disk.

11. The system of claim 8, wherein the each of the plurality of data clusters comprises one or more virtual machines, wherein each of the one or more virtual machines is configured to perform a specific role within the data cluster.

12. The system of claim 8, wherein the processor-executable instructions, on execution, cause the processor to:
identify a data cluster from the plurality of data clusters as an ephemeral data cluster based on the set of usage metrics; and
reconfigure the identified data cluster to an ephemeral data cluster.

13. The system of claim 8, wherein the processor-executable instructions, on execution, cause the processor to present the one or more recommendations to a user device via a Graphical User Interface (GUI).

14. The system of claim 8, wherein to determine the justification based on the predefined threshold, the processor-executable instructions, on execution, cause the processor to compare each of the set of usage metrics with the corresponding predefined threshold.

15. A non-transitory computer-readable medium storing computer-executable instructions for optimizing resource utilization in cloud-based data processing platform, the computer-executable instructions configured for:
for each data cluster of a plurality of data clusters in a cloud-based data processing platform,
receiving a set of usage metrics of the data cluster using a web crawler;
determining a justification based on a predefined threshold corresponding to each of the set of usage metrics of the data cluster through one or more Application Programming Interfaces (APIs);
generating one or more recommendations based on the justification for optimal usage of the data cluster through the one or more APIs; and
executing the one or more recommendations through at least one of an associated configuration file or the one or more APIs.

16. The non-transitory computer-readable medium of claim 15, wherein the computer-executable instructions are further configured for retrieving the set of usage metrics of each of the plurality of data clusters based on a predefined time interval.

17. The non-transitory computer-readable medium of claim 15, wherein the set of usage metrics comprises utilization information of each of a control processing unit, a memory, and a disk.

18. The non-transitory computer-readable medium of claim 15, wherein the computer-executable instructions are further configured for:
identifying a data cluster from the plurality of data clusters as an ephemeral data cluster based on the set of usage metrics; and
reconfiguring the identified data cluster to an ephemeral data cluster.

19. The non-transitory computer-readable medium of claim 15, wherein the computer-executable instructions are further configured for presenting the one or more recommendations to a user device via a Graphical User Interface (GUI).

20. The non-transitory computer-readable medium of claim 15, wherein for determining the justification based on the predefined threshold, the computer-executable instructions are configured for comparing each of the set of usage metrics with the corresponding predefined threshold.
